(19) United States
(12) Patent Application Publication
(10) Pub. No.: US 2011/0024202 A1
(43) Pub. Date: Feb. 3, 2011

(54) HEIGHT AND WEIGHT SCALE

(76) Inventor: Shian-Tsong Chen, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 12/534,061

(22) Filed: Jul. 31, 2009

(51) Int. Cl. G01G 19/387

(52) U.S. Cl. 177/245

(57) ABSTRACT

A height and weight scale includes a holder block mounted inside a main housing, a vertical rail affixed to the holder block, a belt wheel pivotally mounted on the bottom side of the vertical rail, a height measuring plate slidably coupled to the vertical rail, a belt coupled between the belt wheel and the height measuring plate and rotatable to move the height measuring plate up and down along the vertical rail, a driven gear affixed to the belt wheel for rotating the belt wheel, and a driving mechanism formed of a motor mount, a motor, an encoder and a belt transmission mechanism for rotating the encoder and the belt wheel synchronously so that the encoder accurately indicates the height of the user after the height measuring plate is moved along the vertical rail and stopped at the top side of the user's head.

### BACKGROUND OF THE INVENTION

(a) Field of the Invention

The present invention relates to a measuring instrument and more particularly to a height and weight scale for accurately measuring the height and weight of a person.

(b) Description of the Prior Art

A known electronic height and weight scale generally comprises a main housing, a weight measuring unit located on the front side of the main housing, and a height measuring device mounted on the back side of the main housing. The height measuring device comprises a hollow long bar that is affixed at its bottom end to the main housing, a belt mounted inside the hollow long bar and rotatable by a driving mechanism, and a height measuring plate slidably mounted on the hollow long bar and coupled to the belt. Thus, the height measuring device and the weight measuring unit are operated at the same time to measure the weight and height of a person.

According to the aforesaid prior art design, the driving mechanism uses a clutch to drive the belt, i.e., spring members are arranged in the bottom side of the hollow long bar at one lateral side relative to the belt wheel to force a respective steel ball into engagement with a clutch disc. When the motor of the driving mechanism is started to rotate the clutch disc, the belt wheel and the belt are rotated, thereby moving the height measuring plate along the hollow long bar. However, using the spring members to force the respective steel balls into engagement with the clutch disc is not a perfect design. The spring members start to wear after a long use. When elastic fatigue occurs in the spring members, the whole electronic height and weight scale will be unable to function well, and a maintenance work will be necessary.

### SUMMARY OF THE INVENTION

The present invention has been accomplished under the circumstances in view. It is the main object of the present invention to provide a height and weight scale, which uses a motor to rotate a belt wheel in moving a height measuring plate via a belt, so as to improve measuring accuracy and reduce the frequency of maintenance.

To achieve this and other objects of the present invention, a height and weight scale comprises a holder block mounted inside the main housing of the height and weight scale, a sliding track assembly and a driving mechanism. The sliding track assembly comprises a vertical rail fastened to the holder block, a belt wheel pivotally mounted on a bottom side of the vertical rail, a height measuring plate coupled to and movable along the vertical rail, a belt extending along the vertical rail and coupled between the belt wheel and the height measuring plate and rotatable to move the height measuring plate up and down along the vertical rail, and a driven gear affixed to the belt wheel for rotating the belt wheel. The driving mechanism comprises a motor mount, a motor mounted on the motor mount, an encoder mounted on the motor mount and disposed at one lateral side relative to the motor, and a belt transmission mechanism coupled between the motor and the encoder for enabling the encoder to be rotated by the motor, the belt transmission mechanism comprising a drive gear meshed with the driven gear for rotating the driven gear to rotate the belt wheel in moving the height measuring plate synchronously upon rotation of the motor for measuring the height of a person.

### BRIEF DESCRIPTION OF THE DRAWINGS

FIG. 1 is an elevational view of a height and weight scale in accordance with the present invention.

FIG. 2 is a sectional rear side view of the height and weight scale in accordance with the present invention.

FIG. 3 is an exploded view of a part of the present invention, showing the structure of the holder block, sliding track assembly and driving mechanism of the height and weight scale.

FIG. 4 is a sectional side view of the assembly of the holder block, sliding track assembly and driving mechanism of the height and weight scale according to the present invention.

FIG. 5 is an exploded view of a part of the present invention, showing the structure of the driving mechanism.

### DETAILED DESCRIPTION OF THE PREFERRED EMBODIMENTS

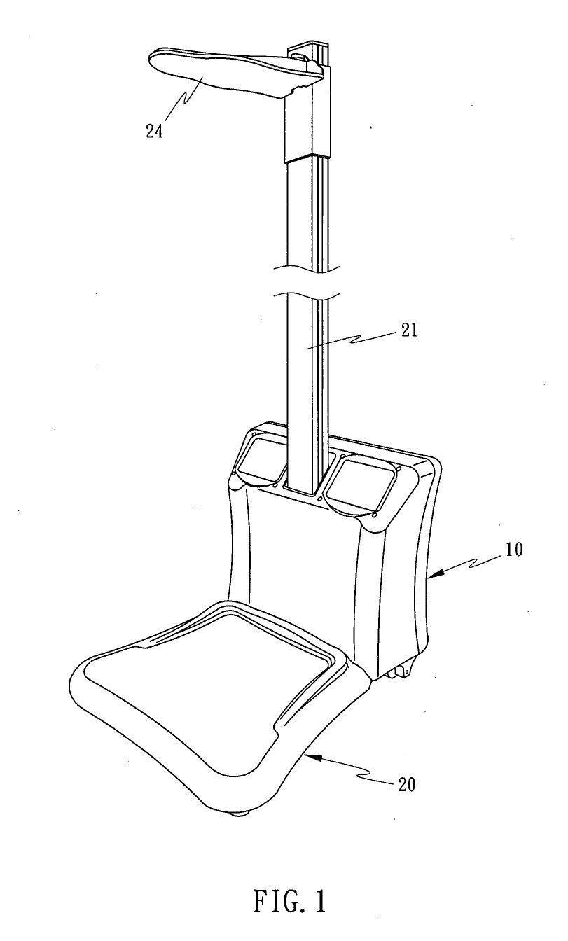

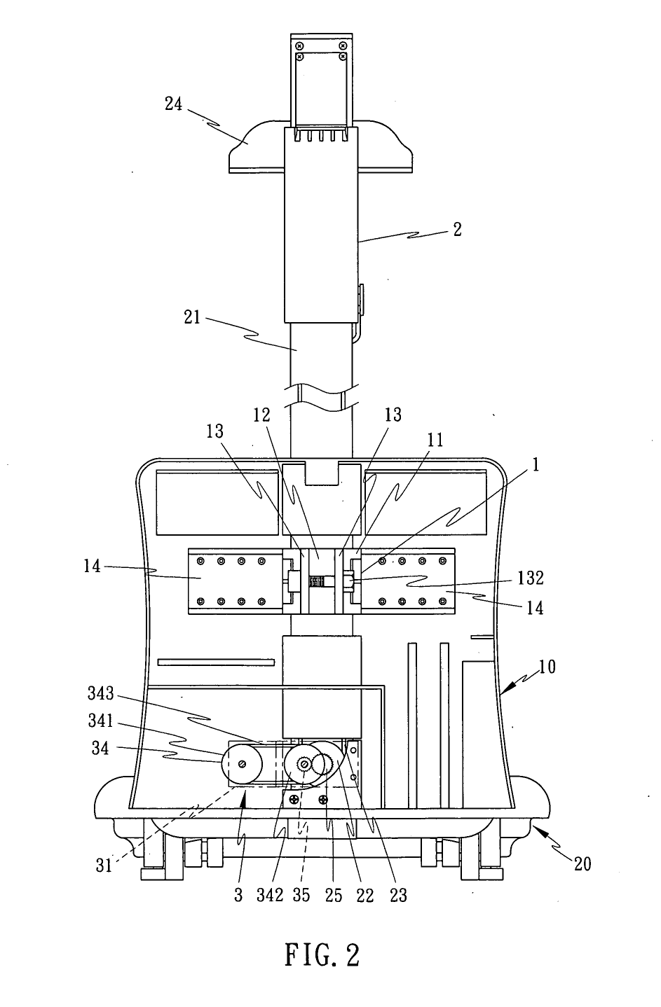

As illustrated in FIGS. 1 and 2, a height and weight scale in accordance with the present invention comprises a holder block 1, a sliding track assembly 2 and a driving mechanism 3.

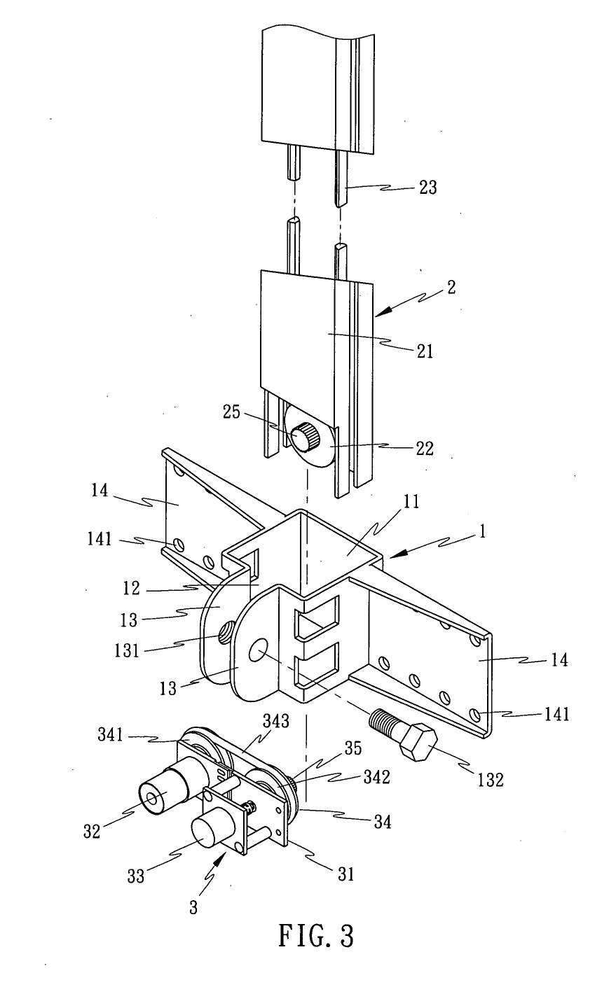

The holder block 1, as shown in FIG. 2 and FIG. 3, is mounted inside the main housing 10 of the height and weight scale, having a hollow base 11 shaped like a rectangular tube, a front opening 12 located on the front side of the hollow base 11, two lugs 13 respectively extending from the hollow base 11 at two opposite lateral sides of the front opening 12, a screw hole 131 located on each of the lugs 13 for the mounting of a screw bolt 132, two wing plates 14 respectively extending from two opposite lateral sides of the hollow base 11, and a plurality of mounting screw holes 141 respectively located on the wing plates 14 for fixation to the inside of the main housing 10 of the height and weight scale.

The sliding track assembly 2, as shown in FIG. 2 and FIG. 3, comprises a vertical rail 21 made in the form of a hollow, narrow, rectangular box and fastened to the hollow base 11 of the holder block 1, a belt wheel 22 pivotally mounted on the bottom side of the vertical rail 21, a height measuring plate 24 coupled to and movable along the vertical rail 21, a belt 23 inserted through the hollow base 11 of the holder block 1 and coupled between the belt wheel 22 and the height measuring plate 24 and rotatable to move the height measuring plate 24 up and down along the vertical rail 21, and a driven gear 25 affixed to the belt wheel 22 for rotating the belt wheel 22 synchronously.

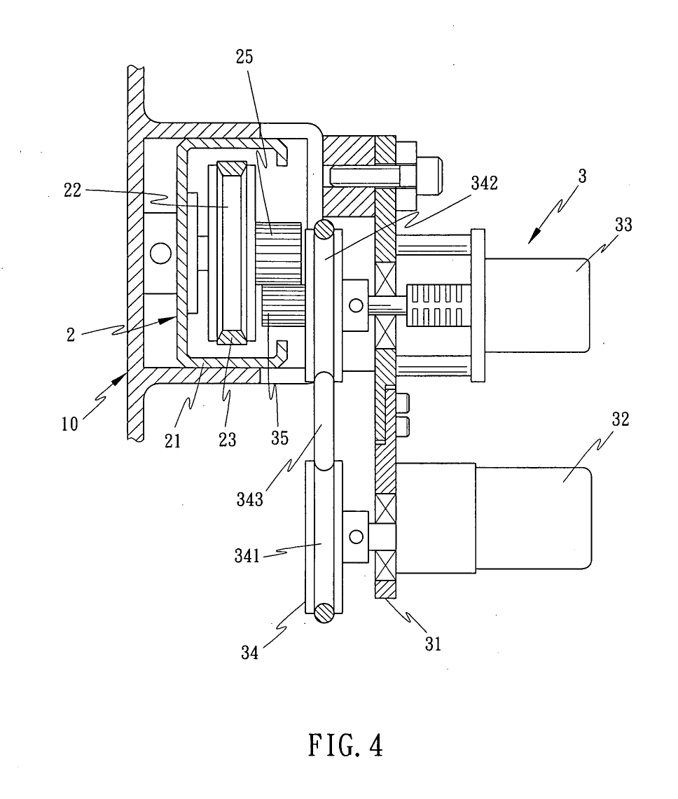

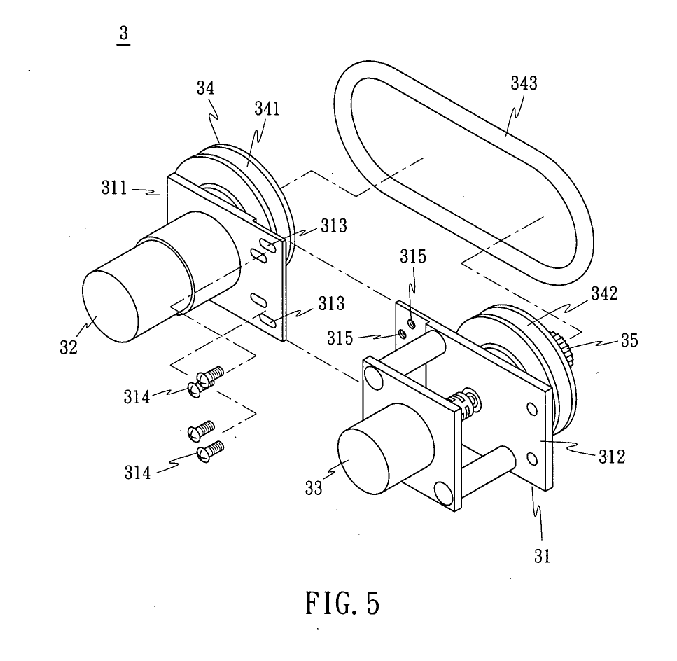

The driving mechanism 3, as shown in FIG. 4 and FIG. 5, comprises a motor mount 31, a motor 32 mounted on one side of the motor mount 31, an encoder 33 mounted on the same side of the motor mount 31 and disposed at one lateral side relative to the motor 32, a belt transmission mechanism 34 coupled between the motor 32 and the encoder 33 for enabling the encoder 33 to be rotated by the motor 32, and a drive gear 35 rotatable by the belt transmission mechanism 34. As shown in FIG. 2 and FIG. 5, the driving mechanism 3 is mounted inside the main housing 10 of the height and weight scale at a selected location to keep the drive gear 35 in mesh with the driven gear 25 of the sliding track assembly 2.

Referring to FIG. 4 and FIG. 5, the motor mount 31 of the driving mechanism 3 is formed of a first plate member 311 and a second plate member 312 that are fastened together by a lap joint. The first plate member 311 supports the motor 32. Further, the first plate member 311 has a plurality of oblong mounting slots 313 near its one end and a plurality of screws 314 respectively inserted through the oblong mounting slots 313. The second plate member 312 supports the encoder 33. Further, the second plate member 312 has a plurality of screw holes 315. The screws 314 are respectively threaded into the screw holes 315 to affix the first plate member 311 and the second plate member 312 together, thereby forming the motor mount 31. When the screws 314 are loosened, the relative position between the first plate member 311 and the second plate member 312 can be adjusted for regulating the belt tension of the belt transmission mechanism 34. The belt transmission mechanism 34 comprises a drive pulley 341 coupled to and rotatable by the motor 32, a driven pulley 342 coupled to the encoder 33 and adapted for rotating the encoder 33, and a transmission belt 343 coupled between the drive pulley 341 and the driven pulley 342. The aforesaid drive gear 35 is mounted on one side of the driven pulley 342 for synchronous rotation with the driven pulley 342.

To use the weight and height scale, the user stands on the weight measuring unit, referenced by 20, at the front side of the main housing 10 of the height and weight scale. After the height and weight scale is started, the weight measuring unit 20 measures the user's body weight, and at the same time the motor 32 of the driving mechanism 3 is started to provide a rotary driving force through the belt transmission mechanism 34, the drive gear 35 and the driven gear 25, belt wheel 22 and belt 23 of the sliding track assembly 2 to the height measuring plate 24 and the encoder 33 synchronously. Therefore, when the height measuring plate 24 is lowered to the top side of the user's head and stopped, the encoder 33 provides a data indicative of the user's height. According to the present invention, a driving force is transferred from the driving mechanism 3 to the sliding track assembly through the drive gear 35 and the driven gear 25. Further, the drive gear 35 and the driven gear 25 are properly arranged to match with the functioning of the belt transmission mechanism 34 and the belt wheel 22, assuring power transmission accuracy and eliminating the intensive maintenance problems of the prior art design. Further, the motor mount 31 is formed of the first plate member 311 and the second plate member 312 that are adjustably connected together by a lap joint, facilitating adjustment of the belt tension of the transmission belt 343 of the belt transmission mechanism 34 and achieving the effects of convenient and practical use.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A height and weight scale, comprising:
a main housing;
a holder block mounted inside the main housing;
a sliding track assembly, said sliding track assembly comprising a vertical rail fastened to said holder block, a belt wheel pivotally mounted on a bottom side of said vertical rail, a height measuring plate coupled to and movable along said vertical rail, a belt extending along said vertical rail and coupled between said belt wheel and said height measuring plate and rotatable to move said height measuring plate up and down along said vertical rail, and a driven gear affixed to said belt wheel for rotating said belt wheel; and
a driving mechanism, said driving mechanism comprising a motor mount, a motor mounted on said motor mount, an encoder mounted on said motor mount and disposed at one lateral side relative to said motor, and a belt transmission mechanism coupled between said motor and said encoder for enabling said encoder to be rotated by said motor, said belt transmission mechanism comprising a drive gear meshed with said driven gear of said sliding track assembly for rotating said driven gear to rotate said belt wheel in moving said height measuring plate synchronously upon rotation of said motor for measuring the height of a person.

2. The height and weight scale as claimed in claim 1, wherein said holder block comprises a hollow base shaped like a rectangular tube for receiving a bottom end of said vertical rail, a front opening located on a front side of said hollow base, two lugs respectively extending from said hollow base at two opposite lateral sides of said front opening, a screw hole located on each of said lugs, and a screw bolt fastened to the screw hole on each of said lugs to affix the bottom end of said vertical rail to said hollow base.

3. The height and weight scale as claimed in claim 1, wherein said holder block comprises a hollow base shaped like a rectangular tube for receiving a bottom end of said vertical rail, two wing plates respectively extending from two opposite lateral sides of said hollow base, and a plurality of mounting screw holes respectively located on said wing plates for fixation to the inside of said main housing; said vertical rail of said sliding track assembly has a bottom side inserted into said hollow base and affixed thereto.

4. The height and weight scale as claimed in claim 1, wherein said motor mount comprises a first plate member holding said motor, said first plate member having a plurality of oblong mounting slots disposed near one lateral side thereof, a second plate member holding said encoder, said second plate member having a plurality of screw holes, and a plurality of screws respectively inserted through said oblong mounting slots and threaded into said screw holes to affix said first plate member and said second plate member together.

5. The height and weight scale as claimed in claim 1, wherein said belt transmission mechanism comprises a drive pulley coupled to and rotatable by said motor, a driven pulley coupled to said encoder for synchronous rotation, and a transmission belt coupled between said drive pulley and said driven pulley; said drive gear is connected to one side of said driven pulley for synchronous rotation with said driven pulley.
